(19) United States
(12) Patent Application Publication
(10) Pub. No.: US 2005/0240409 A1
(43) Pub. Date: Oct. 27, 2005

(54) System and method for providing rules-based directory assistance automation

(76) Inventor: Lorin R. Gallistel, Rochester, NY (US)

Correspondence Address: JENKENS & GILCHRIST, PC, 1445 ROSS AVENUE, SUITE 3200, DALLAS, TX, 75202, US

(21) Appl. No.: 10/458,862

(22) Filed: Jun. 11, 2003

(51) Int. Cl. G10L 21/00

(52) U.S. Cl. 704/270

(57) ABSTRACT

A system and method for providing directory assistance automation to a caller in a telecommunications environment utilizes dedicated processors to convert caller utterances (e.g., corresponding to city, state and listing name) using automated speech recognition technology to grammar strings that are then employed in searching of a listing database. Automation instructions for guiding the database searches are provided via various mapping and rules tables or in separate predefined search logic. Selected rules tables can be programmed by a telecommunications provider to implement customized instructions. Such specialized access may be provided by way of a graphical user interface at the directory assistance automation system.

### FIELD OF THE INVENTION

The present invention generally relates to automated directory assistance applications for telephone companies and other telecommunications service providers. More particularly, the present invention relates to a directory assistance automation (DAA) application with defined logic as well as rules options for improving automation capabilities, thus reducing the amount of required interaction between a caller and a live operator.

### BACKGROUND OF THE INVENTION

Telecommunications networks have been developed to interconnect a large number of users among various source and destination locations throughout the world. Users in a telecommunications network may operate from either a fixed line or wireless location that may be characterized as residential, commercial, business, or otherwise. Each such user line or location is often identified by a unique telephone number, and various compilations of such identifying information have been established to enable access to and organization of such information. The simplest example of such a compilation is a “telephone book” that is often issued by a local telecommunications company to provide a collection of its customer listings.

Yet another source for accessing information regarding various telecommunications customers is a directory assistance (DA) line (such as 411 in the United States), which typically connects a user to a live operator who can then communicate with the user to determine and provide desired customer information. The operator thus serves as the interface between the user and a directory assistance (DA) database, which is an electronic compilation of customer listings that is conventionally developed and maintained by telecommunications service providers.

Although this type of directory assistance is typically very reliable in terms of returning the correct information desired by a user, it is highly dependent on the availability of many essential resources, including time and manpower. As such, computerized applications have been developed for many large telecommunications service providers for providing front-end directory assistance with at least partial automation. By automating aspects of a directory assistance line, the amount of time live operators spend servicing calls is reduced, and in some cases even eliminated.

Known commercially viable directory assistance applications in a carrier network have been developed that are capable of providing full automation of customer calls about 5-10% of the time. The automation steps implemented by such known DA applications are prespecified and must be synchronized with a DA database. When additional increments of automation are desired for such an application, the number of prespecified automations increases. Due to a sharp drop off in the frequency of request as additional listing names are added to such an automation table, the cost of commissioning additional automation increases rapidly. Furthermore, since a DA database often changes on a daily basis, DA applications in accordance with prior technology must frequently be synchronized with their corresponding DA database. Any subsequently required changes in automation based on changes to the DA database must again be manually preprogrammed by maintenance staff, resulting in the additional expenditure of cost and time.

Known attempts to directly interface prior DA applications to a DA database such that the application implements a direct search thereof have also been made, but were characterized by various shortcomings. As such, many telecommunications service providers have not been outfitted with automated directory assistance applications. Thus, it is desired to provide a reliable and affordable DAA application with improved automation features for use in various telecommunications networks.

### SUMMARY OF THE INVENTION

Objects and advantages of the invention will be set forth in part in the following description, or may be obvious from the description, or may be learned through practice of the invention. The present subject matter recognizes and addresses various drawbacks and other shortcomings related to certain conventional directory assistance services for telecommunications networks. Thus, the presently disclosed technology is directed to an improved system and method for providing directory assistance automation features in a telecommunications environment such that more abundant and reliable automation of incoming directory assistance calls is facilitated.

Although having particular usefulness for telecommunications networks, and especially to Carrier VoIP networks, it should be appreciated that the present invention is not limited to this use. Aspects of the invention may be used with other information systems or in environments other than a telecommunications network. Such uses may be known or become apparent to those skilled in the art and are within the spirit and scope of the invention. For illustrative purposes, embodiments of the disclosed technology according to the invention may be explained herein as they relate to a telecommunications network.

Aspects of the present subject matter concern a generally modular directory assistance automation (DAA) system for interfacing with an operator services switch in a telecommunications network. The DAA system is configured to interact with a DA database to search and obtain various customer listing information as requested by a caller. Utilization of the subject DAA system preferably results in a significant number of incoming DA calls to be fully automated. However, in cases where the DA call cannot be automated or can only be partially automated, a live operator interface is also provided. The present subject matter equally concerns methodology implemented by the DAA system and other related components.

In some exemplary embodiments of the present subject matter, a method for providing directory assistance automation to a caller in a telecommunications environment includes the initial step of prompting a caller for utterances for a desired call listing Voice prompts may request from a caller such information as the city, state, and listing name for a desired call listing. Additional provisions, such as automated speech recognition software executed on at least one dedicated processor, are provided to convert the received caller utterances to recognition string(s). Various tables, such as a grammar mapping table, a grammar-tag-to-rules table, and various rules tables are stored in memory associated with another dedicated processor that implements additional aspects of the subject DAA technology. These tables are accessed to determine if any search-related instructions are provided for a desired listing. Such tables may also be accessed after a database search to provide instructions for subsequent handling of a given call after searching has been done. Additional instructions may be provided via a subset of predefined search logic that help deduce how to automatically handle a call or portion thereof. A DA database is then searched by the application in accordance with the defined rules, if any, corresponding to that listing and one or more listings are then returned from the DA database. If the set of candidate listings returned can be reduced to a single one through a combination of rules and post-processing logic, then the listing is provided to the caller via, for example, via an audio announcement system. Otherwise, additional caller interaction may be used to elicit additional responses to facilitate the candidate selection or the formation of a subsequent DA database search. Alternatively, the call may be sent directly to an operator for further assistance.

A particular advantage of aspects of the present subject matter corresponds to providing directory assistance automation (DAA) application that allows for searching of a DA database in a much more dynamic fashion. Accessible rules tables may be predefined with various specific mapping and directive instructions. Furthermore, a separate set of generic fixed logic may be provided as default or supplemental instructions for searching the DA database and obtaining desired listing information. Such generic logic may also be employed in data handling decisions and resolving of candidate listings when more than one listing is returned in a search of the DA database. The variety of different rules tables and application features facilitates a DAA application with great design versatility.

Yet another advantage of some exemplary embodiments of the subject DAA technology is that many of the steps and components are provided in a distinct fashion to ensure some independency among features while easing the process of implementing future system modifications. For example, some embodiments of the present invention provide separate processors for different functional aspects of DAA technology. Another exemplary advantage in component independency relates to separation of the DAA application and the DA database. Because the DA database is searched directly by the DAA system, as opposed to making a separate copy of the database, the design does not introduce additional maintenance, which otherwise would be required to keep the DA database and the copy in complete synchronization. Such design facilitates the implementation of updates or changes to residential or business listings in the DA database.

A still further advantage of the presently disclosed technology is that a DAA system is provided that enables a much higher rate of fully automated DA calls. A fully automated DA call is defined as one that does not require interaction with a live operator, but that is handled in its entirety by the DAA system and its automated computerized interaction with the DA database and other system components interfaced to an operator services switch. Where previously implemented commercially viable systems in a carrier network have been known to achieve fully automated call rates of about 5-10%, the DAA system disclosed herein typically provides 15-20% fully automated call rates and can in many instances provide an even higher rate such as 30-40% and above. It should be recognized that methods and statistical data for calculating such rates of fully automated call success may vary, and thus advantages of the subject DAA system can be most appropriately recognized for their relative improvement over rates associated with previous automated systems.

Yet another advantage of the present subject matter is that the searches performed by the subject DAA system are focused as narrowly as possible to ensure that the DAA system only retrieves as much information as necessary from the DA database. By attempting to only retrieve listings that have a high probability of containing requested information, search efficiency is maximized and a more efficient use of network bandwidth is effected. Furthermore, a limited amount of returned information to the DAA system reduces or eliminates the need for a search interface to support the return of an excessively large number of listings.

Other aspects and features of the present subject matter will become apparent to those ordinarily skilled in the art upon review of the following description of specific embodiments of the invention in conjunction with the accompanying figures.

### BRIEF DESCRIPTION OF THE DRAWINGS

The above and other aspects, features, and advantages of the present subject matter will be more apparent from the following more particular description of particular embodiments of the invention as set forth in the appended figures, in which:

FIG. 1 provides a block diagram illustration of exemplary components in a telecommunications network, including components associated with an operator services switch and DAA system in accordance with the present invention;

FIG. 2 provides a block diagram illustration of exemplary components of an DAA system in accordance with the present invention; and

FIG. 3 provides a flow chart representation of exemplary steps in accordance with a method for providing DAA services to a caller in accordance with the present invention.

Repeat use of reference characters throughout the present specification and appended drawings is intended to represent same or analogous features or elements of the presently disclosed technology.

### DETAILED DESCRIPTION

Reference will now be made in detail to embodiments of the invention, one or more examples of which are illustrated in the figures. The embodiments are provided by way of explanation of the invention, and not as a limitation of the invention. For example, features illustrated or described as part of one embodiment may be used with another embodiment to yield a still further embodiment. These and various other modifications and variations may be made to the embodiments set forth herein without departing from the spirit and scope of the invention.

As mentioned, embodiments of the invention have particular usefulness for telecommunications networks, and especially Carrier VoIP networks, although the invention should not be limited to this use. The invention may have application in any industry or environment wherein it is necessary or desirable to provide features for automated information retrieval based on spoken language input. For purposes of explaining certain aspects of the invention, reference is made to embodiments of the invention particularly configured for incorporation in a telecommunications network environment.

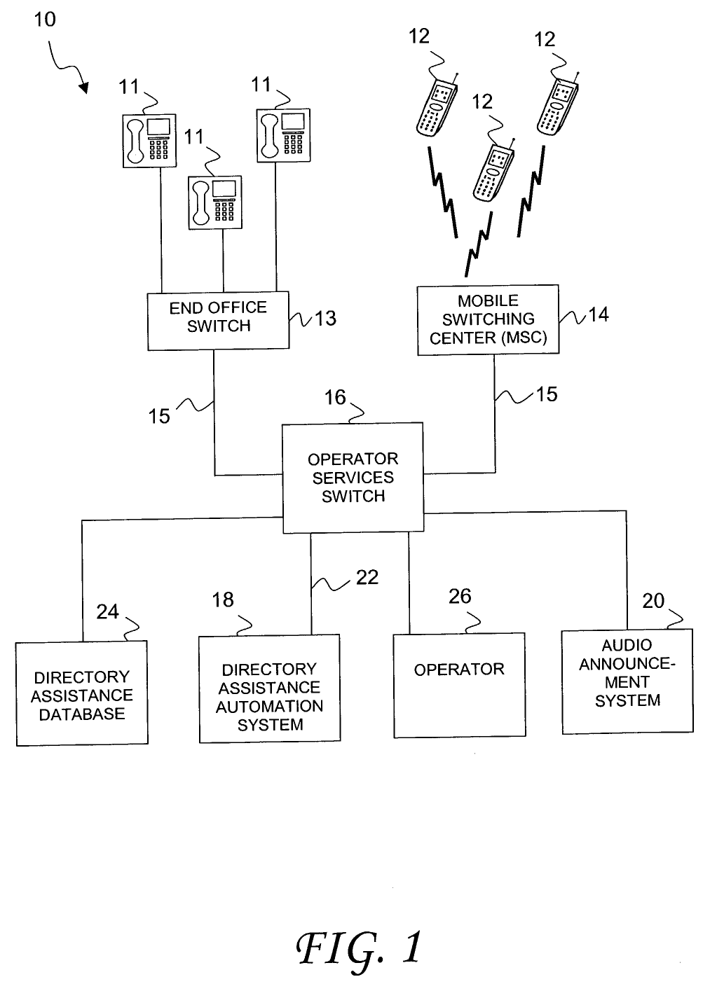

With reference to FIG. 1, a simple illustration is presented of an exemplary telecommunications network 10 with which a DAA system in accordance with the present invention may operate. More particularly, telecommunications network 10 includes a plurality of fixed line subscriber units 11 and mobile subscriber units 12, with which various users may access the telecommunications network 10. Each fixed line subscriber unit 11 is connected to a predetermined end office switch 13 and each mobile subscriber unit 12 is connected to a mobile switching center (MSC) 14 which may then establish a path among various source and destination subscriber units 11 and 12. A specific example of the type of switching hardware provided at end office switches 13 and MSCs 14 is a Class 5 TDM switch, as conventionally utilized in telecommunications networks today. Other tandem switching elements may alternatively be provided at switching locations 13 and 14. It should be appreciated that switching locations 13 and 14 are typically coupled to a relatively large number of respective subscriber units 11 and 12, for example many orders of magnitude more than the three respective subscriber units depicted per switching location in FIG. 1. Such illustration is presented merely for the sake of convenience.

Each switching location 13,14 is then typically configured to connect calls from a source subscriber unit 11,12 to some other destination subscriber unit 11,12. Switching locations 13,14 are typically connected to other larger switching elements (not illustrated in FIG. 1) which can then route voice traffic to other locations in a telecommunications network. Depending on the intended voice traffic path, such larger switching elements for connecting calls may correspond to, for example, a class 4 TDM switch, an interexchange carrier (IXC), an internet service provider (ISP) or other type of centralized media switch.

Another particular category of voice traffic that may exist in a telecommunications network is that corresponding to directory assistance (DA) calls. When DAA systems are available in a given telecommunications network, a caller may dial a specifically designated number (such as 411 in the United States) for indicating a desired connection to such an information service. When a subscriber unit dials a directory assistance number (e.g., 411), the subscriber unit call is directed to an operator services switch 16 via, for example, T-1 carrier transmission lines 15. A specific example of an operator services switch is a TOPS (Traffic Operator Position System) brand switch such as offered for sale by Nortel Networks.

When a subscriber unit call is routed to operator services switch 16, switch 16 hands off the call to a DAA system 18, which presents a dialog to collect the caller's information request. Such dialog is typically in the form of a plurality of voice prompts requesting information such as the city, state, and listing name. After the voice prompts are presented to a caller, automated speech recognition (ASR) technology provided with the DAA system 18 (to be discussed later in further detail) is employed to recognize the caller utterances and convert such utterances to grammar recognition strings that are representative of the information spoken by the caller. ASR features are provided in the DAA system 18 and the caller's voice channel is routed on line 22 from the operator services switch 16. When interaction is needed between the DAA system 18 and other network elements such as the audio announcement system 20, DA database 24 and operator 26, such communication is routed back through the operator services switch 16. It should be appreciated that alternative communication routes, such as direct communication between the DAA system 18 and elements 20, 24 and 26 may be implemented in alternative embodiments of the present technology.

Referring still to the operator services aspects of telecommunications network 10, the caller utterances and resultant grammar recognition strings form the basis of a search of a DA database 24. DA database 24 is a collection of information typically generated and maintained by various telecommunication service providers. The information stored in DA database 24 includes information such as city, state, and listing name for all residential, commercial, business and customers of other classifications as exist in various telecommunications service areas. Prior to performing a search of the DA database 24, DAA system 18 performs a lookup of the city and listing name in a Rules Table to extract instructions for performing the search. The Rules Table may contain rules that apply to all listings as well as rules that are specific to certain listing names. The extracted instructions may contain refinements of the name and city text to increase search success rates and to manage the amount of information retrieved and thereby decrease the load on the searched database 24 as well as on the network. In addition, the instructions for some listings may contain directives to the DAA system 18 to prompt the caller for additional information beyond the city, state and listing name, for example, such as the street name. This additional information may be obtained prior to the search and then used as part of the search criteria. Such instructed directives may also be employed after search results are returned. Many other pre-search rules and/or directives may also be specified, as discussed later in further detail. Based on the information provided by the caller, the DAA system 18 then performs a search of listings in the DA database 24 to retrieve candidate records matching the call parameters. When search results have been returned from the DA database 24, post-search rules or supplemental search logic may be implemented to guide the DAA system 18 in resolving the list of candidates to a single telephone number or more limited set of numbers. Rules may be employed to emulate operator practices specific to particular service providers such that specialized rules for the DAA system can be implemented.

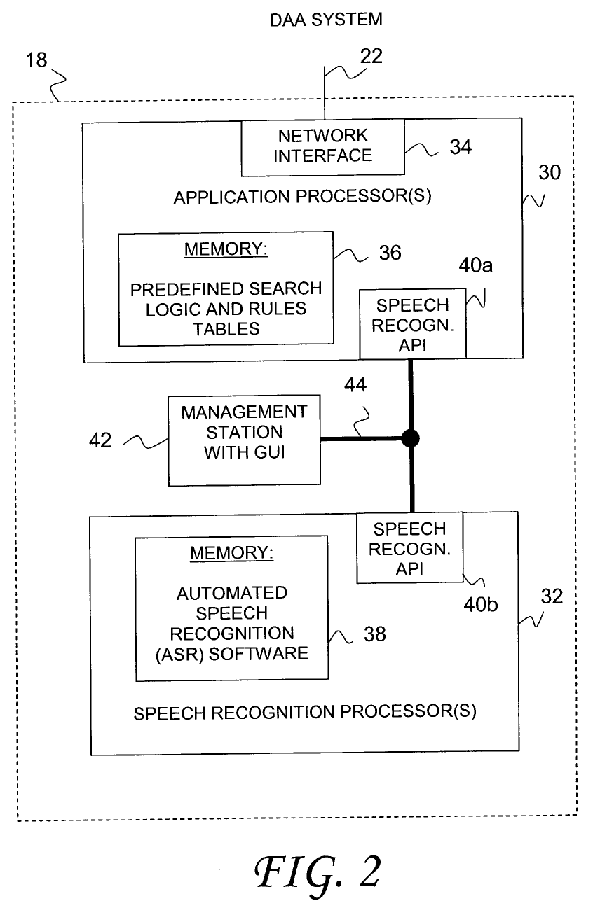

Referring now to FIG. 2, a more detailed block diagram illustration of exemplary elements of DAA system 18 is presented. DAA system 18 may include at least a first (front-end) processor 30 and a second (back-end) processor 32. Processor 30 is referred to herein as an “application processor” and processor 32 is referred to herein as a “speech recognition processor” and could respectively correspond to any type of processors or computing platforms as readily available and understood by one of skill in the art. It should be appreciated that each such processor 30, 32 may actually be embodied by multiple respective processors, or both first and second processor(s) may correspond to a distributed collection of processors with various resources dedicated to the different ASR and application technology presented herein (for example, by way of parallel processing). By providing general purpose computing platforms for the application and speech recognition processing capabilities, the DAA system 18 is able to take advantage of the rapid increase in computing power at the same platform cost. Furthermore, separate application and speech recognition processing capabilities facilitates expansion of or improvements to the respective processors and elements thereof. For instance, if improved ASR software becomes available, the speech recognition processor can be upgraded accordingly without modification to the application processor. Similarly, if name changes or emergency rule directives need to be made to the rules tables and/or predefined search logic in the application processor, such instances can be handled without interfering with the speech recognition processor. Although some of these particular advantages may not be recognized, it should still be appreciated that in some embodiments of the present invention, a single processor can be utilized to deploy both the DAA application as well as the speech recognition engine.

Referring still to FIG. 2, incoming voice traffic on line 22 is first provided to application processor 30, where a network interface 34 is provided to execute a protocol common with the operator services switch to facilitate transfer of the digitized voice data between the operator services switch and the application processor. In some embodiments, network interface is a hardware card that takes the digital voice on line 22 and separates it into multiple samples called “features” defined by a recognized amplitude, duration, frequency and/or other desired signal properties. Although network interface 34 as illustrated is located as a physical component in the application processor 30, it should be appreciated that the network interface 34 may be provided as a separate functional element of the subject directory assistance technology.

Referring still to FIG. 2, application processor 30 may include dedicated memory 36, corresponding to either main memory or virtual memory, for storing various tables, databases, and instructional software utilized by the application processor 30. Memory 36 includes at least the various rules tables and other tables that will be described later in more detail and the predefined search logic that can be either configured through the rules tables or provided separately. Memory 36 may also include stored data or software for the application processor to utilize for providing initial and/or subsequent voice prompts to a caller. Speech recognition processor 32 also has a dedicated memory module 38 for storing automated speech recognition (ASR) software, speech recognition grammars, and any other necessary instructions or variables for use by processor 32. A specific example of an ASR software package for use by the speech recognition processor 32 is the OpenSpeech Recognizer brand speech recognition engine as offered for sale by Speechworks. It should be appreciated that alternative speech recognition engines may be utilized in accordance with the present technology, and that as advances to existing speech recognition technology are realized, such improved speech recognition engines may also be employed. Each of processors 30 and 32 is provided with a speech recognition API (application programming interface) 40a and 40b, that may be part of the respective software processes stored in memory modules 36 and 38. It should be appreciated that additional or alternative memory modules may be provided for storing software instructions, tables, and other information as needed for DAA system 18.

Another feature of DAA system 18 as depicted in FIG. 2 is a management station 42 having a graphical user interface (GUI) that is accessible by the telecommunications service provider to enable their control of selected aspects of the automation process. The management station 42 is preferably coupled to the other elements of DAA system 18 via any type of communication mechanism, such as a high speed Local Area Network (LAN). In such case, appropriate network interfaces may be included in GUI 42 and speech recognition processor 32. The GUI interface preferably enables the service provider to enter new rules and maintain existing rules. By enabling the service providers to control automation datafill to some practical extent by way of the management station and GUI 42, the DA database 18 is afforded with increased functionality and design versatility.

With more particular reference to the management station and GUI 42, users or staff with access to such management station are preferably allowed to define and adjust the rules established in the rules tables in memory 36 of the application processor 30. Such rules may be adjusted, as necessary, to achieve maximum automation, to change the rules set, or to specify particular listings or classes of listings to exclude from automation. Listing exclusions (for example, police emergency, hospital emergency room, and other listings) may be defined such that the DAA system 18 does not attempt to automate the call, but rather sends the call to an operator and plays back the caller's response(s) in a store and forward mode in addition to populating the recognized information on the operator's terminal. A table of exclusion listings may be maintained as a separate table with independent provisions than the other various tables in memory 36. Management station with GUI 42 also provides an ability to enter and maintain other information besides rules, such as entering and managing of application and speech recognition datafill, enabling and disabling system processors, as well as other system and networking management functions.

The amount of control that a telecomnunications service provider has over aspects of the DAA system 18 via the management station and GUI 42 can vary depending on the capabilities of the predefined search logic instructions defined in the DAA system 18 and the specific listings sought by a subscriber. For instance, it may be desirable in certain applications that when establishing rules for a specific listing, the service provider has access to specific listing elements by way of a pop-up selection box as opposed to having to manually type in such listing elements. An example of a type of rule that may be defined for specific listings may, for example, emulate existing operator service policies for a telecommunications network provider. For instance, whenever a listing is requested for a car dealership, a rule may be established that always provides the number for the sales 16 department of the requested car dealership or particular category of car dealerships. Similarly, if a listing is requested for a drug store or particular category of drug stores, a rule may be established that always asks the caller if he or she wants the main number or the pharmacy number for the requested drug store or particular category of drug stores. The option to establish a rule for a particular category of listings provides a more convenient option than establishing multiple rules for each separate listing in the particular category.

An aspect of the presently disclosed directory assistance automation technology is to provide two separate features for implementing automation within the application processor 30. More particularly, these two separate features correspond to rules tables, some aspects of which may be particularly defined by the telecommunications service provider via management GUI 42, as well as a predefined search logic, which is a generic relatively small set of instructions over and above the rules tables that is totally non-specific to the service providers. Generic logic specifically addresses data handling decisions that can be made independent of the listing semantics. For example, the rule that, for example, for Business Name A in Locality W the automation system should first prompt the caller for “what street” would be semantics-based knowledge and therefore contained only in the rules tables. However, consider the example that two listings are returned from the DA database search and the automation application then tests to determine if the names are different or if the street names are different, and then uses the determined information as a basis for a potential subsequent prompt to the caller. This type of situation corresponds to search knowledge contained in generic rules. As a further clarification, rules tables determine search knowledge based on the “meaning” of various search strings, while generic logic determines search knowledge based on textual differences in the search strings.

A more particular example of the type of predefined search logic that is implemented with the present DAA application may correspond to a situation when two or more listings have been returned from the DA database 24 for a given subscriber request, and there is no rules table entry providing instructions that specify what action to take at that point. It is an underlying objective of the present DAA system 18 to return just one listing from the DA database when that is possible. The DAA system 18 would automatically try and deduce the next correct action to take based on the predefined search logic. For instance, the system can compare the street names corresponding to the two or more returned listings and determine if those are different. In the case that they are different, the DAA system 18 can play a navigation prompt asking the caller to distinguish between the street name options. Appropriate action for deducing the desired listing is then taken based on the caller's response.

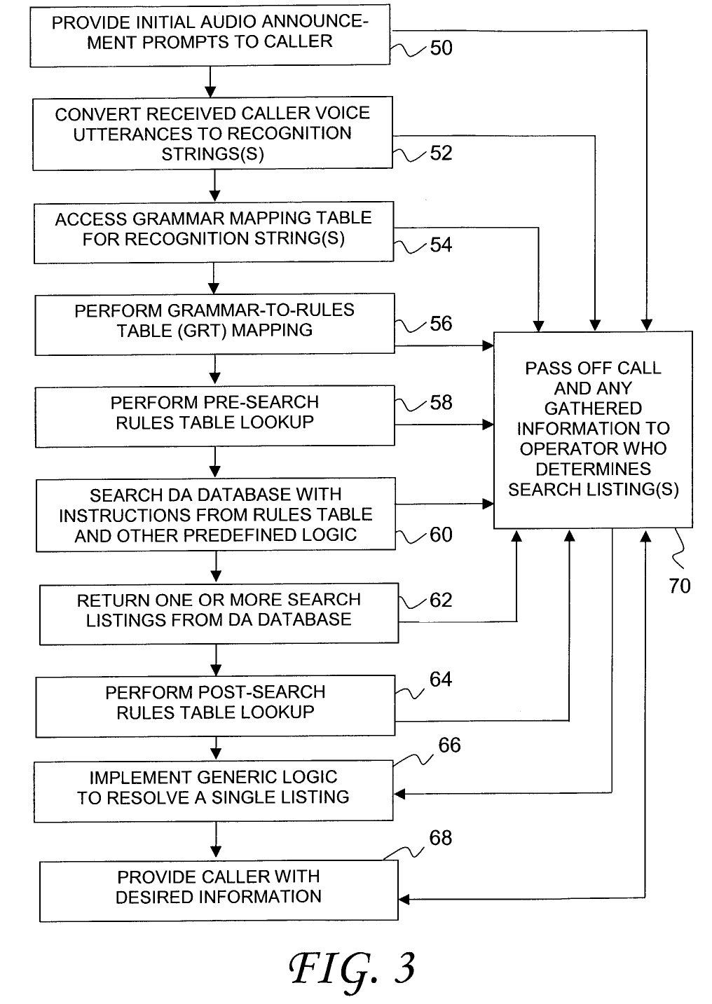

Now referring to FIG. 3, a more particular description of various exemplary steps in the methodology implemented in accordance with the subject DAA technology is presented. A fundamental goal of a DAA system in accordance with the presently disclosed technology is to map a caller's voice request to one or more listings in the DA database 24. A first step 50 corresponds to providing initial audio prompts to a caller. The prompts are played by the application processor and may correspond, for example, to requests for a caller to provide the city, state and listing name for the desired listing. After a caller provides a voice response to the prompts provided in step 50, a second step 52 is to convert the received caller utterances into one or more recognition strings, also referred to herein as grammar. In some instances, a unique alphanumeric grammar tag will be assigned to each different recognition string to facilitate identification and subsequent sorting of the information in the DAA system. Such voice conversion is implemented by the DAA system 18, particularly by the ASR engine defined in software instructions that are executed by the speech recognition processor 32.

Referring still to the exemplary methodology of FIG. 3, a next step 54 corresponds to accessing a grammar mapping table for the one or more grammar recognition strings obtained via the ASR technology. A grammar mapping table is utilized to ensure that grammar strings can be placed into proper format for searching the database. This intermediate table ensures that neither the database nor grammar would need to be changed to effect the required correspondence. This is particularly useful for minimizing differences as simple as singular versus plural forms or as complex as a complete string transformation. For example, if a subscriber requests the listing information for either “XYZ Pizza” or “XYZ's Pizza” in a given city and state, the grammar mapping table will match up both corresponding grammar tags for the resultant recognition string(s) to the same rules table index. An exemplary portion of such a grammar mapping table is shown below in Table 1. It should be appreciated that an actual grammar mapping table stored in the dedicated or virtual memory 36 of application processor 30 may be defined in a variety of different forms.

TABLE 1
EXEMPLARY GRAMMAR MAPPING TABLE ENTRIES

| RECOGNITION | | |
|---|---|---|
| STRING(S): | GRAMMAR TAG: | RULES TABLE INDEX: |
| XYZ Pizza | 25388 | 23512 |
| XYZ's Pizza | 25389 | 23512 |

Other differences between recognition strings and entries in a DA database may be handled in a more arbitrary fashion in a separate table from the grammar mapping table. Such table may be referred to herein as a “Grammar-Tag-to-Rules Table,” and may also be utilized as in step 56 of the exemplary methodology in FIG. 3 to associate various grammar tags for different reasons than the minor discrepancies resolved in the grammar mapping table. For example, if a subscriber requests the listing information for either “XYZ Pizza” or “XYZ Pizza Delivery” in a given city and state, the Grammar-Tag-to-Rules mapping table will match up both corresponding grammar tags for the resultant recognition string(s) to the same rules table index. This example is based on the assumption that there would not be a separate delivery number for such a listing. An exemplary portion of such a table is shown below in Table 2. It should be appreciated that an actual table as stored in the dedicated memory 36 of application processor 30 may be defined in a variety of different forms.

TABLE 2
EXEMPLARY GRAMMAR-TAG-TO-RULES TABLE

| RECOGNITION | | |
|---|---|---|
| STRING(S): | GRAMMAR TAG: | RULES TABLE INDEX: |
| XYZ Pizza | 25390 | 23452 |
| XYZ Pizza Delivery | 25391 | 23452 |

### Entries

After the application processor accesses the various tables stored in memory 36 to distinguish among such discrepancies as may be handled via a grammar mapping table or a grammar-tag-to-rules table, a next step 58 of the subject directory assistance automation methodology is to perform a pre-search rules table lookup. By performing a rules table lookup prior to actually searching the DA database, the DAA system is able to utilize any qualifying information specified there to perform the database search. Not all listings will have a corresponding entry in the Rules Tables, but there will typically be a large number of entries. It should be appreciated that the number and type of rules tables for access by application processor 30 may be readily varied depending on software preferences. At a minimum, the rules table will provide the name and city search criteria. In other words, after the grammar entry tag is used to index into the Grammar-Tag-to-Rules Table 1 in step 56 to retrieve a corresponding rules table index, a lookup is done in the rules table via the table index to extract all the search criteria to ensure the most efficient and qualified search for that request is effected.

A rules table entry in accordance with the presently disclosed DAA technology may exist to simply map a given grammar entry to the correct search name string. For example, a grammar entry “ABC Hardware” might be associated with a listing name “XYZ Hardware” on “ABC Road”. A sample rules table entry according to this example is shown below in Table 3.

TABLE 3
EXEMPLARY RULES TABLE ENTRY

| Table | Listing | Name | City | Directive | | Quali- |
|---|---|---|---|---|---|---|
| Index | Group # | String | String | (D) | Qualifier 1 | fier 2 |
| 2011 | 1 | XYZ | Mayville | S | Sales | |
| | | Hardware | | | | |

The exemplary rules table entry shown above also contains an example of a search directive, or instruction for the DAA system regarding how to proceed with searching for a desired listing. For example, the directive “S” could be used to indicate to the DAA system to search the DA database not only for the name string of “XYZ Hardware” but to further use the listed qualifier in the search request. A search of the DA database based on the exemplary rules table entry of Table 3 would thus preferably yield the listing information for the sales number of XYZ Hardware. In this exemplary rules table configuration, the DAA system would access the rules table with both the table index and the group number of “1” Listing Group index. This Listing Group number can be utilized to indicate that any general rule for that listing is provided in the first entry of the database. The DAA system could look for other members of a group in case the general rule is over-ridden by a specific rule for a different condition (e.g., for a different city).

Another example of a rules table entry in accordance with the presently disclosed DAA technology may correspond to one that exists to map a given grammar string to the correct city name string. For example, a caller may request the listing information for “JKL Salon” in “Town M,” but the actual location of the JKL Salon is in the nearby suburb of “Town N.” An entry in the rules table(s) or in a separate city name mapping table could then be accessed to find instructions for the DAA system to search using a desired city name. For this example, the DA database would be searched automatically for the city string of “Town N” when the city recognition string is “Town M.” This portion of the rules table or a city name mapping table may be designed for modification by the telecommunications service provider to indicate instances when appropriate city names can be clarified for a particular listing. Such a table would reduce the need to make sure that the correct name strings exist in the DAA system when the grammar recognition strings are established and would reduce the need for ASR and grammar rebuilds when an error is made in establishing the recognition strings.

A still further example of a rules table entry in accordance with the present subject matter corresponds to the situation when rules specific to a given telecommunications service provider are desired to be implemented. Such rules may be programmed by the service provider via the GUI management station 42 as previously discussed. For example, it may be desired to always release the information number when a listing request for an “ABC Hardware” is made. The exemplary rules table entries shown below in Table 4 are presented to illustrate two different ways in which an “ABC Hardware” listing request may be handled by the application processor.

TABLE 4
EXEMPLARY RULES TABLE ENTRY

| | | | | Di- | | |
|---|---|---|---|---|---|---|
| | | | | rec- | | |
| Table | Listing | Name | City | tive | | |
| Index | Group # | String | String | (D) | Qualifier 1 | Qualifier 2 |
| 9152 | 1 | ABC | | S | Information | |
| | | Hardware | | | | |
| 9152 | 2 | ABC | Location | N | Information | Contractor |
| | | Hardware | P | | | Desk |

The first entry in Table 4 is an example of a general rule for “ABC Hardware.” The city string field is not filled in, so this rule would be applied to an ABC Hardware listing request for any city except those which may be listed with the same table index (e.g., 9152) but a different listing group. The “S” directive for this first entry corresponds to instructions for the DAA system to use the following qualifiers (e.g., information listing number) to “Search” the DA database. The second entry in Table 4 is an exception to the general rule for an “ABC Hardware” listing request in Location P. The “N” directive in this case means that the DAA system is to “Navigate” between the following qualifiers, an “Information” listing number and a “Contractor Desk” listing number. Such navigation would correspond to prompting the caller for additional information to distinguish between the two qualifier options. Because the navigation in this particular instance is specified, the DAA system can do the navigation prior to a search of DA database 24 and then do a fully qualified search with the caller's obtained selection to thereby narrow the returned result to a single listing. Since it is often desirable to limit the volume of the number of returned listings, it is typically beneficial to retrieve only a single listing from the DA database 24 as opposed to an entire caption set or many individual listings.

There may be instances when there is not an entry in the rules tables for a given listing request. In such situations, the implication is that the listing grammar and city grammar entries obtained from the caller's voice and subsequent ASR conversion are adequate to resolve the search. For example, “RST Bar and Grill” in a given city and state might have just a single entry in the listing grammar and that entry along with the city name might be adequate to retrieve the listing, so there is no need for further instructions provided in the rules table.

Referring again to the exemplary steps illustrated in FIG. 3, after the step 58 of performing the pre-search rules table lookup is effected, the DA database is searched in step 60 in accordance with the instructions obtained via the rules tables and any other non-service provider specific predefined search logic as previously discussed. Subsequently, one or more search listings are retrieved from the DA database in step 62 based on the qualifiers and instructions identified in step 60. Step 64 corresponds to the option of performing a post-search rules table lookup for providing any instructions for subsequent handling of the DA request. Examples similar to those presented with regard to the pre-search rules table lookup of step 58 are applicable for the post-search rules table lookup in step 64. A subsequent step 66 in the exemplary method of automatically providing a caller with a requested directory assistance listing is to implement generic logic via the application processor to determine if a listing can be released to audio announcement in step 68. For example, if a single listing remains at this step, then the decision would likely be to release the listing to announcement. If multiple listings remain, then generic logic might lead to another set of actions (for example, subsequent provision of prompt(s) to a caller based on comparison of the remaining lists, additional DA database searching, transfer to an operator, or other actions). As soon as the DAA system resolves the search to a single listing, the system may provide the caller with the desired information in step 68, via the audio announcement system interfaced to the DAA system.

With further regard to FIG. 3, it should be appreciated that at various times during the automation process discussed with respect to the present invention, the call can be transferred to a live operator. Such a transfer may be particularly beneficial when the DAA system does not narrow the amount of returned listings to a reasonably acceptable amount. When such a transfer is made as represented by step 68, for this or other types of reasons, any information already obtained via the DAA system 18 is also preferably relayed to live operator 26, so that no previously effected directory assistance efforts are lost.

While the invention herein disclosed has been described by means of specific embodiments, numerous modifications and variations could be made thereto by those skilled in the art without departing from the scope of the invention set forth in the claims. Accordingly, the scope of the present subject matter should be assessed as that of the disclosed variation of embodiments and any equivalents thereto.

1. A method of automatically mapping a caller's voice request to one or more search listings in a directory assistance (DA) database, said method comprising the following steps:
converting a caller utterance to at least one recognition string that is representative of the listing information spoken by a caller;
performing a rules table lookup to determine if any variable automation instructions exist for said at least one recognition string;
searching a DA database while implementing any variable automation instructions identified in the rules table via said performing step and while implementing any predefined automation instructions applicable to said at least one recognition grammar string; and
returning one or more identified search listings from the DA database.

2. A method as in claim 1, further comprising the initial step of providing audio prompts to a caller requesting the caller to provide verbal indication of identifying characteristics of a desired directory listing.

3. A method as in claim 2, wherein the identifying characteristics that a caller is prompted to provide include the city, state and listing name for a desired directory listing.

4. A method as in claim 1, wherein said step of performing a rules table lookup comprises performing a variable mapping to obtain a rules table index and subsequently accessing a rules table entry corresponding to the obtained rules table index such that any variable automation instructions for the desired search listing or category of search listings are identified.

5. A method as in claim 1, further comprising the step of performing a subsequent rules table lookup to determine if any variable automation instructions exist for the one or more identified search listings from said returning step.

6. A method as in claim 5, further comprising the step of providing the caller via an audio announcement system with the desired search listing information.

7. A method as in claim 1, further comprising the step of passing the directory assistance call to an operator along with any information obtained via said converting and returning steps.

8. A directory assistance automation (DAA) system for interfacing with a telecommunications network, said DAA system comprising:
memory for storing programmable rules tables and predefined search instructions;
at least one application processor in communication with said memory, said at least one application processor configured to reference the rules tables and process the predefined search instructions within said memory as associated with a process of searching a database of directory listings;
automated speech recognition software defining instructions to convert a caller utterance to a text string established for subsequent processing thereof; and
at least one speech recognition processor for implementing said automated speech recognition software, said at least one speech recognition processor coupled to said at least one application processor such that the text string obtained by said at least one speech recognition processor can be employed as a reference to the rules tables and predefined search instructions stored in said memory.

9. A directory assistance automation (DAA) system as in claim 8, further comprising an additional allocation of memory associated with said at least one speech recognition processor for storing said automated speech recognition software.

10. A directory assistance automation (DAA) system as in claim 8, further comprising a network interface coupling the DA system to the telecommunications network, said network interface configured to receive a caller's voice signal from the telecommunications network and to format the voice signal into digital samples thereof.

11. A directory assistance automation (DAA) system as in claim 8, further comprising a comprehensive database of directory listings that is accessed by said at least one application processor and searched for a desired listing based on a caller's listing request and any corresponding rules table instructions or predefined search logic instructions.

12. A directory assistance automation (DAA) system as in claim 8, further comprising respective speech recognition application programming interfaces (APIs) associated with the at least one application processor and at least one speech recognition processor to establish compatible communication between such respective processors.

13. A directory assistance automation (DAA) system as in claim 8, further comprising a management station having a graphical user interface (GUI), said management station providing an interface a user to send and maintain functional features of the DAA system.

14. A directory assistance automation (DAA) system as in claim 8, further comprising an audio announcement system for providing identified listing information to a caller.

15. A directory assistance automation (DAA) system for interfacing with a telecommunications network to receive digital voice signals therefrom and provide directory assistance automation capabilities, said DAA system comprising:
means for converting a digital voice signal to at least one recognition string that is representative of the listing information spoken by a caller;
means for performing a rules table lookup to determine if any variable automation instructions exist for said at least one recognition string;
means for implementing any variable automation instructions identified in the rules table for said at least one recognition string and also for implementing any predefined automation instructions applicable to said recognition string; and
means for searching a DA database in accordance with said variable automation instructions and said predefined automation instructions and identifying any search listings in the DA database that map to the at least one recognition string and that comply with the variable and predefined automation instructions.

16. A directory assistance automation (DAA) system as in claim 15, further comprising means for providing audio prompts to a caller requesting the caller to provide verbal indication of identifying characteristics of a desired directory listing.

17. A directory assistance automation (DAA) system as in claim 16, wherein the identifying characteristics that a caller is prompted to provide include the city, state, and listing name for a desired directory listing.

18. A directory assistance automation (DAA) system as in claim 15, further comprising means to provide the caller with the desired search listings identified in the DA database.

19. A directory assistance automation (DAA) system as in claim 15, further comprising means for passing the directory assistance call to a live operator along with any information obtained automatically via the DAA system.

20. A directory assistance automation (DAA) system as in claim 15, further comprising means for storing programmable tables and predefined search instructions.

21. A directory assistance automation (DAA) system as in claim 15, further comprising means for interfacing the DAA system to the telecommunications network such that a caller's voice signal received from the telecommunications network is formatted into digital samples thereof for subsequent processing by the DA database.

22. A directory assistance automation (DAA) system as in claim 15, further comprising means for entering and maintaining selected entries in the rules tables.
